(19) United States
(12) Patent Application Publication
(10) Pub. No.: US 2013/0347112 A1
(43) Pub. Date: Dec. 26, 2013

(54) METHOD FOR A FINE OPTICAL LINE MONITORING IN COMMUNICATION LINES THROUGH QKD SYSTEMS

(71) Applicants: Vicente Martin Ayuso, Madrid (ES); Daniel Lancho Lancho, Madrid (ES); Mercedes Soto Rodriguez, Madrid (ES); Jesus Martinez Mateo, Madrid (ES)

(72) Inventors: Vicente Martin Ayuso, Madrid (ES); Daniel Lancho Lancho, Madrid (ES); Mercedes Soto Rodriguez, Madrid (ES); Jesus Martinez Mateo, Madrid (ES)

(73) Assignee: TELEFONICA, S.A., Madrid (ES)

(21) Appl. No.: 13/997,709

(22) PCT Filed: Dec. 26, 2011
(86) PCT No.: PCT/EP2011/074053

§ 371 Date: Sep. 11, 2013

(30) Foreign Application Priority Data
Dec. 29, 2010 (ES) P201032001

(51) Int. Cl. H04L 29/06

(52) U.S. Cl. CPC H04L 63/1408
USPC 726/23

(57) ABSTRACT

Two ends of a QKD system are connected through a private quantum channel using a protocol based on the principles of quantum physics and a conventional channel, both channels being introduced through the same medium using multiplexing techniques, wherein a possible intrusion in the communication is detected by checking the variability of the distribution of exchanged photons between both ends of said private quantum channel and in case of detecting an intrusion due to the risk identified on the communication channel the system launches an alarm. To avoid other attacks another conventional channel different from the quantum channel is further used in order to check the error rate in the exchanges.

### FIELD OF THE ART

The present invention generally relates to a method for the analysis and detection of spies in optical communications, and more particularly to a method comprising the use of QKD systems to check the variability of the distribution of exchanged photons in order to detect an intrusion.

### PRIOR STATE OF THE ART

In a quantum key distribution system (QKD), two peers exchange a key using a protocol based on the principles of quantum physics [1, 2, 3, 4]. In order to exchange the key, the two ends of a QKD system need two communication links: a quantum channel and a conventional and authenticated channel. A quantum channel can be considered a channel because it is used to transmit information coded in qubits that are eventually used to compose the final key shared by the two ends of the communication. The transmission medium commonly used for the quantum channel is the optical transmission medium (currently fibre optic) and the physical element used for coding the qubit is the photon [5].

The conventional and quantum channels can coexist in the same medium using two multiplexing techniques: Time Division Multiplexing (TDM) or Frequency Division Multiplexing (WDM). These modulation techniques also allow the use of other communication channels and, therefore, the integration of QKD systems in conventional communication systems.

Only with the Frequency Division Multiplexing technique (WDM) the signal transmission is performed in different channels simultaneously, allowing the increase of the volume of information transmitted in the same medium per unit of time. This increase of the transmission capacity of the medium is particularly interesting, for instance, to expedite communications required by the protocols used on the basis reconciliation, error correction [6] and privacy amplification [7, 8]. There are existing alternatives for key distillation, such as LDPC codes, which can reduce network traffic between the extremes of a QKD system [9]. The two most commonly used standards for frequency multiplexing in the optical transmission medium are Coarse WDM and Dense WDM (CWDM and DWDM respectively). Commercial optical networks built using passive technology, i.e. Passive Optical Networks (PON), allow the use of quantum communication channels, because the signals transmitted on a PON network are not intercepted by the presence of intermediate components. These channels can coexist simultaneously with other channels of different technology using frequency division multiplexing.

A remarkable problem of this medium is that communications made through an optical transmission channel are easily accessible. The most elusive methods do not require physical intrusion of the medium, i.e. do not interrupt the transmission through the optical medium, which makes almost impossible the detection of attacks. This type of non-intrusive access also allows the use of these techniques in communication technologies based on PON as long as it does not interrupt the transmission through the medium, always keeping the passive nature of the network in each communication between nodes.

In order to perform an attack, a relatively simple way to avoid interrupting a line in an optical transmission medium is to use a curved coupler (coupler bend). The coupler is used to provoke a critical radius curve to the optical media, where there is a small spatial dispersion in the core of the optical transmission medium, thereby resulting in a fraction of light escaping it. Placing a detector where the light escapes can be useful to intercept the data exchanged, capturing a small portion of the transmitted signal. These couplings will necessarily lead to power losses in the optical signal transmitted which may be very small, what makes really complicated the detection of the attack. Curved couplers are not rare instruments which makes their availability relatively simple to an attacker.

Much of the efforts applied in the implementation of secure communication systems are focused on the possibility to access the means by which communication takes place in order to attack. The physical access control is really complicated in global communications networks, as well as in urban areas where optical transmission lines are located in centres of population, or trunk lines of communication where it is not possible to track a physical inspection of the whole line.

There are solutions for intrusion detection in optical networks. Some of these existing solutions use power meters, or reflectometers, to detect an intrusion (both strategies are also used to check an optical transmission channel after it has been completely deployed). It would be easy for an skilled spy not to be detected if this type of strategy is used.

### DESCRIPTION OF THE INVENTION

The integration of QKD systems in real communication environments allows their use to detect possible interventions of the transmission medium of communication.

Under ideal conditions, i.e. single photon sources, the ends of a single photon QKD system can be exchanged through the optical media. The emission and detection of the photon is produced in different ends of the QKD system, so any intermediate element will influence this exchange. The intervention of the optical transmission element can then be detected by the QKD system accurately considering the number of photons absorbed in the transmission.

QKD systems can be integrated with communication systems based on networks with optical transmission media when using PON technologies, and also simultaneously when using WDM to multiplex various communication channels. Therefore, the use of QKD systems for key exchange in a network can be used in addition to check whether the communication line is being spied in any of the communication channels.

The invention allows extending QKD systems' use cases to add intrusion detection uses in conventional communication lines. QKD systems originally designed for key exchange can be used in the analysis of security of the medium avoiding the need to pay for other alternative technological solutions that facilitate the detection of attacks on the environment.

### BRIEF DESCRIPTION OF THE DRAWINGS

The previous and other advantages and features will be clarified with the following detailed embodiments, with reference to the attached drawings, which must be considered in an illustrative and non-limiting manner, in which:

FIG. 1 shows a QKD system used to detect intrusions. There is a monomode fibre that connects the two ends of the two-node network, a modulator which incorporates two different frequencies within the same optical fibre using WDM, a transponder to operate the conventional communication channel, and two ends which one is a single photon emitter (Alice) and the other one the single photon detector (Bob).

FIG. 2 shows the general case in an optical network. The two elements of the QKD system are placed one at each end of the optical path that wants to remain secure. The system monitores the line characterization so it raises an alarm in case of error.

FIG. 3 shows the general case in a shared optical network. As there is more than one detector it is necessary to use TDM techniques. In the following sequence diagram it can be observed an example with one Alice and two Bobs

FIG. 4 shows a network of TDM-PON access that can be incorporated in the present invention.

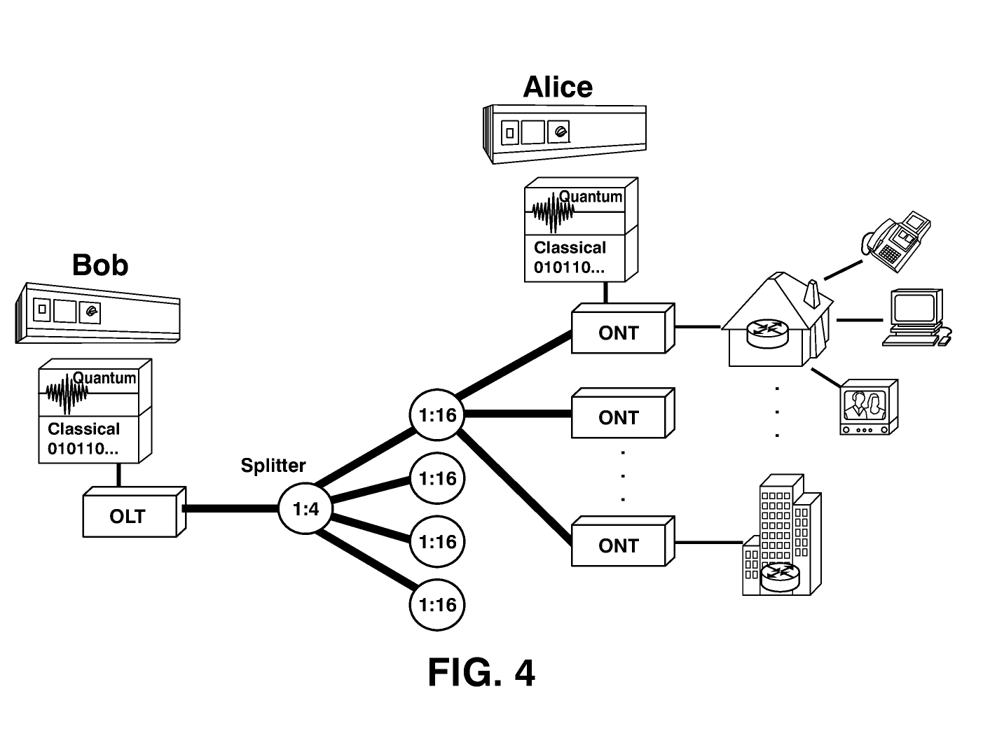

FIG. 5 shows a metropolitan network based on ROADM switches that can be incorporated in the present invention.

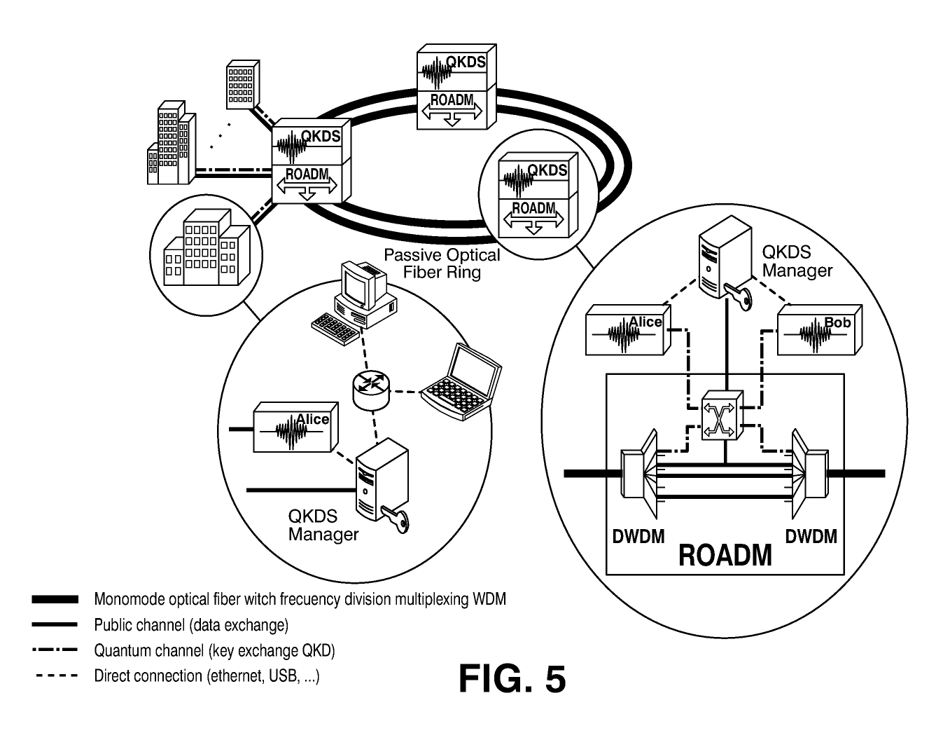

### DETAILED DESCRIPTION OF SEVERAL EMBODIMENTS

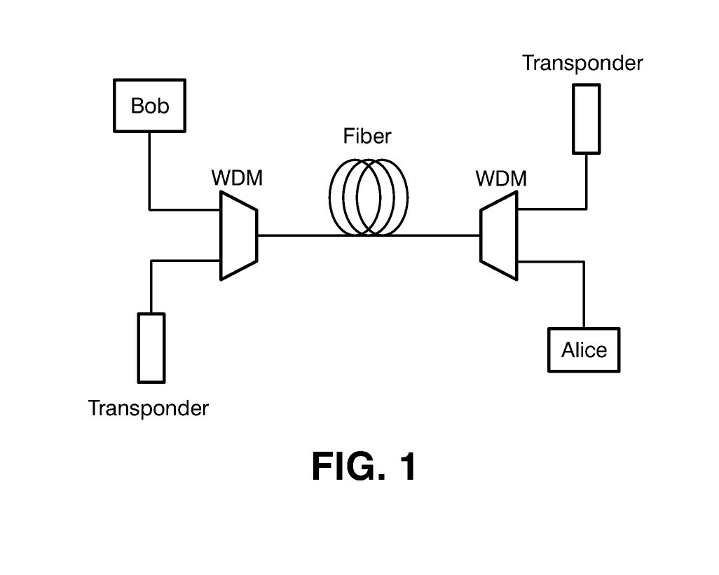

The simplest case for the implementation of the proposed invention is that depicted at the first figure (FIG. 1). It represents only two nodes that form a peer to peer network. Each of the nodes is connected in one end to a QKD system, which we refer as

Alice and Bob respectively. The communication between nodes is done through a single optical transmission line, two-channel multiplexed. The division of the two channels is done by WDM, so that both channels can be used simultaneously. One channel will be used by the QKD system as a quantum channel (in this case used for intrusion detection), while the other channel will be used for the establishment of the communication in a conventional manner.

In this example the QKD system is working as an intrusion detection system and not for key generation, using the quantum channel to check the variability of the distribution of exchanged photons. Any decreasing in the number of photons detected implies that the communication is being partially interrupted by a hypothetical attacker. In this situation, the QKD system can launch an alarm due to the risk identified on the communication channel.

Additionally, the QKD system must complete the distillation process of a key in order to check which the error rate in the exchanges is. With that error rate QKD system may check whether a hypothetical eavesdropper is using other strategies for attack, such as the injection of additional pulses through interception and forwarding strategy (in compensation to the signal intercepted). Key distillation must be performed using a conventional channel different from the quantum channel, so that the scheme proposed to detect intruders requires a more complex scenario, with a minimum of three simultaneous communication channels: one for the quantum channel, one for the conventional channel needed by the QKD system, and a third (minimum) which security is to be ensured by the proposed system. The use of the intrusion detection mechanism proposed in complex communication networks can be done by the integration of QKD systems in these networks, especially using technologies based on passive optical networks (PON), as an extension of the analysis and intrusion detection just described for a two nodes network.

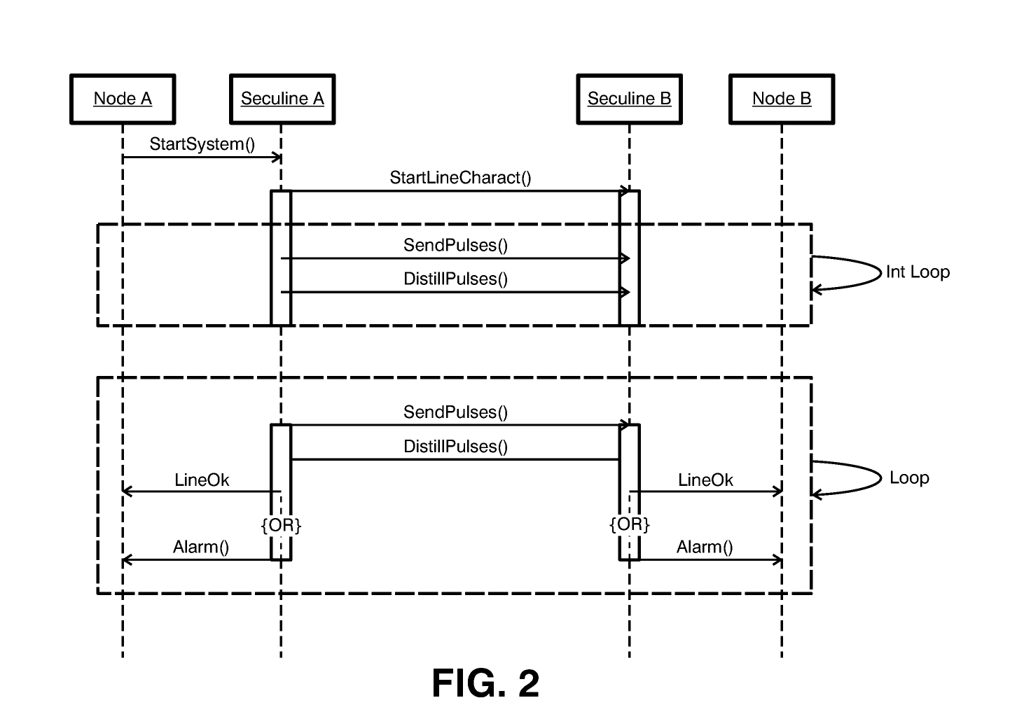

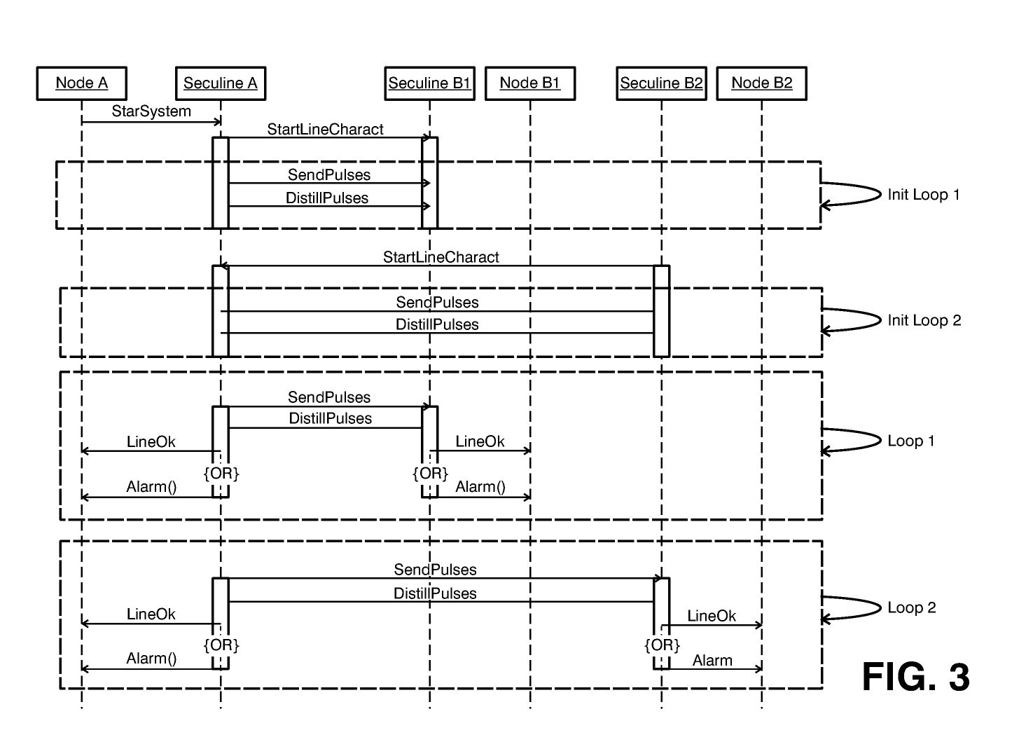

This invention's main goal is to protect any optical network. As it was shown in the general case of an optical network (FIG. 2), the two elements of the QKD System, will be placed one at each end of the optical path that needs to remain secure. Just after the installation it should begin a process of line characterization, where the two ends of the system exchange pulses and distillate the resulting bit string in order to know what the characteristic error of the line is. Once the characterization process has ended, the system continues exchanging pulses and monitoring the error of the line. If this error is bigger than a security parameter, then it raises an alarm. In the case of a shared optical network (FIG. 3) the system can run with one emitter and several detectors, and it's required the use of TDM.

A person skilled in the art could introduce changes and modifications in the embodiments described without departing from the scope of the invention as it is defined in the attached claims.

ACRONYMS AND ABBREVIATIONS

APD AVALANCHE PHOTO-DIODE

CWDM COARSE WDM

DWDM DENSE WDM

FWM FOUR WAVE MIXING

GPON GIGABIT PON

LDPC LOW-DENSITY PARITY CHECK

OLT OPTICAL LINE TERMINAL

ONT OPTICAL NETWORK TERMINAL

PON PASSIVE OPTICAL NETWORK

QBER QUANTUM BIT ERROR RATE

QKD QUANTUM KEY DISTRIBUTION

ROADM RECONFIGURABLE OPTICAL ADD&DROP MULTIPLEXER

TDM TIME-DIVISION MULTIPLEXING

VOA VARIABLE OPTICAL ATTENUATOR

WDM WAVELENGTH-DIVISION MULTIPLEXING

### REFERENCES

[1] C. H. Bennett, G. Brassard, “Quantum cryptography: public key distribution and coin tossing”, Proceedings of IEEE International Conference on Computers, Systems and Signal Processing, IEEE press., pp. 175-179, 1984.

[2] A. K. Ekert, “Quantum Cryptography Based on Bell's Theorem”, Phys. Rev. Lett. 67, Is. 6, pp. 661-663, 1991.

[3] C. H. Bennett, “Quantum Cryptography Using Any Two Nonorthogonal States”, Phys. Rev. Lett. 68, No. 21, pp. 3121, 1992.

[4] V. Scarani, A. Acin, G. Ribordy, N. Gisin, “Quantum cryptography protocols robust against photon number splitting attacks for weak laser pulse implementations”, Phys. Rev. Lett. 92, 2002.

[5] N. Gisen et al., “Quantum Cryptography”, Rev. Mod. Phys. 74, pp. 145, 2001.

1-8. (canceled)

9. A method for a fine optical line monitoring in communication lines using QKD systems, wherein two ends of a QKD system are connected through two communication links: a quantum channel and a conventional channel, said quantum channel using a protocol based on the principles of quantum physics, both channels coexisting in the same medium using multiplexing techniques, wherein a possible intrusion in the communication is detected by checking the variability of the distribution of exchanged photons between both ends of said quantum channel, so that if the number of photons detected is lower than the expected one the communication might have suffered an attack and uses another conventional channel different from the quantum channel in order to check the error rate in the exchanges, so that a minimum of three simultaneous communication channels are used.

10. The method, according to clam 9, wherein in case of detecting an intrusion due to the risk identified on the communication channel an alarm is launched.

11. The method according to claim 9, wherein a first process of line characterization is performed in which the two ends exchange pulses in order to know the characteristic error for the optical path and after that, the system monitores the error of the line and if it is bigger than a security parameter it launches an alarm.

12. The method according to claim 9, wherein said multiplexing technique is a WDM.

13. The method according to claim 12, wherein said multiplexing technique is CWDM or DWDM.

14. The method according to claim 9, wherein the communication line comprises one emitter and several detectors, and said multiplexing technique is a TDM.

15. Then method according to claim 9 wherein said communication line comprises a network of TDM-PON.

16. The method according to claim 9 wherein said communication line comprises a metropolitan network based on ROADM switches.
